(19) United States
(12) Patent Application Publication
(10) Pub. No.: US 2001/0023450 A1
(43) Pub. Date: Sep. 20, 2001

(54) Authoring apparatus and method for creating multimedia file

(76) Inventor: Chang-nam Chu, Seoul (KR)

Correspondence Address: SUGHRUE, MION, ZINN, MACPEAK & SEAS, PLLC, 2100 PENNSYLVANIA AVENUE, N.W., Washington, DC, 20037-3202, US

(21) Appl. No.: 09/768,790

(22) Filed: Jan. 25, 2001

(30) Foreign Application Priority Data
Jan. 25, 2000 (KR) 00-3395

(51) Int. Cl. G06F 15/16

(52) U.S. Cl. 709/231; 709/219

(57) ABSTRACT

An authoring apparatus and method for creating a multimedia file is provided. The authoring apparatus for creating a multimedia file as a source file with respect to a multimedia product, includes an editor for loading a graphics file, an audio file, and a text file which are selected from a file position in a computer designated by a user, generating an audio file in response to a first control signal for controlling the start and end of audio, and reproducing the graphics file and the text file in response to second and third control signals which are generated in synchronization with the reproduction of the audio file, respectively, a control signal generator for checking reproduction time information on the loaded audio file and generating the first through third control signals, a storage unit for storing a graphic image and audio and text data which are reproduced by the editor, and a multimedia file generator for generating the stored data as a multimedia file using a predetermined format.

### BACKGROUND OF THE INVENTION

1. Field of the Invention

The present invention relates to an authoring tool, and more particularly, to an authoring apparatus and method for creating a multimedia file that is reproduced by a multimedia player. The present application is based on Korean Patent Application No. 00-3395, which is incorporated herein by reference.

2. Description of the Related Art

Recently, multimedia players for simultaneously reproducing audio, video, and text files are being widely used. Such multimedia players can be executed after being installed in computers into which sound cards, graphic cards, and application programs for reproducing multimedia files are loaded. Also, the multimedia players can be used as multimedia equipment for reproducing only multimedia files. Users watch images or text, while listening to audio, by executing desired multimedia files through computers or multimedia equipment.

In accordance with the continuing development of multimedia technology, an authoring tool for letting users create multimedia files is needed, in addition to multimedia players for reproducing previously created multimedia files.

### SUMMARY OF THE INVENTION

It is an object of the present invention to provide an authoring apparatus for creating a multimedia file that is capable of letting users easily create source files with respect to multimedia products for reproducing graphics files, audio files, and text files using multimedia file formats.

It is another object of the present invention to provide an authoring method for creating a multimedia file, which is performed by the above apparatus and is capable of facilitating a user interface.

Accordingly, to achieve the first object, there is provided an authoring apparatus for creating a multimedia file as a source file with respect to a multimedia product, comprising an editor for loading a graphics file, an audio file, and a text file which are selected from a file position in a computer designated by a user, generating an audio file in response to a first control signal for controlling the start and end of audio, and reproducing the graphics file and the text file in response to second and third control signals which are generated in synchronization with the reproduction of the audio file, respectively, a control signal generator for checking reproduction time information on the loaded audio file and generating the first through third control signals, a storage unit for storing a graphic image and audio and text data which are reproduced by the editor, and a multimedia file generator for generating the stored data as a multimedia file using a predetermined format.

To achieve the second object, there is provided an authoring method for creating a multimedia file as a source file with respect to a multimedia product, comprising the steps of loading a graphics file, an audio file, and a text file selected from the file position in a computer designated by a user, reproducing an audio file and reproducing graphic and text files in synchronization with the audio reproduction when the user selects an audio reproduction starting button provided on a screen for interfacing with the user, storing a reproduced graphic image and audio and text data, and generating the stored data as a multimedia file using a predetermined format.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram according to a preferred embodiment of an authoring apparatus for creating a multimedia file according to the present invention;

FIGS. 2(a) and 2(b) show preferred embodiments of the format of computer screens according to an authoring method of the present invention; and

FIGS. 3(a) and 3(b) show actual computer screens corresponding to FIGS. 2(a) and 2(b).

### DESCRIPTION OF THE PREFERRED EMBODIMENTS

Hereinafter, an authoring apparatus and method for creating a multimedia file according to the present invention will be described with reference to the attached drawings.

An authoring tool, according to the present invention, creates a source file with respect to a multimedia product for reproducing a graphics file, a text file, and an audio file in synchronization with each other, preferably using a synchronous multimedia integration language (SMIL) format. Also, a music video or an image file, which is created by a user, can be reproduced on a computer screen since a simulation function is included.

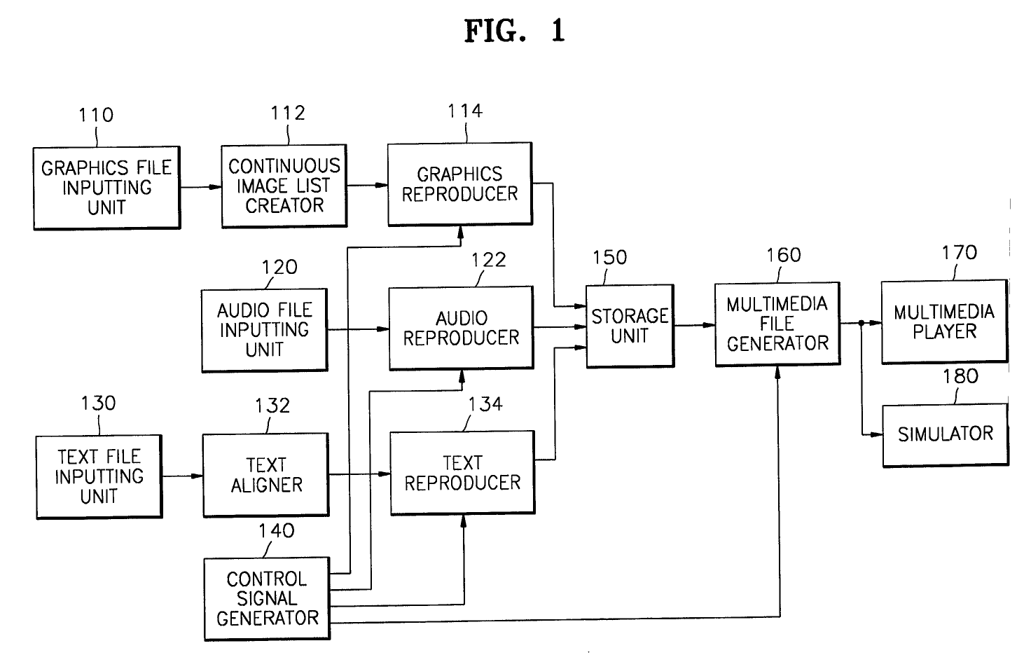

FIG. 1 is a block diagram according to a preferred embodiment of an authoring apparatus for creating a multimedia file according to the present invention.

The authoring apparatus shown in FIG. 1 includes a graphics file inputting unit 110, a continuous image list creator 112, and a graphics reproducer 114 for editing a graphics file, an audio file inputting unit 120 and an audio reproducer 122 for editing an audio file, a text file inputting unit 130, a text aligner 132, and a text reproducer 134 for editing a text file, a control signal generator 140 for controlling the timing of the operations of the reproducers, a storage unit 150 and a multimedia file generator 160 for storing the outputs of the reproducers, and a simulator 180.

A synchronized multimedia integration language (SMIL) applied to the present invention is a multimedia layout language provided by a world-wide web consortium (W3C) and is a markup language application which has a web text format. The SMIL integrates multimedia information such as a text, audio, a picture, and a moving picture and lets the respective information items be synchronized with each other. The authoring apparatus according to the present invention has an editing function for generating and editing files of the SMIL format supported by multimedia products, a reproduction function of showing previously input data using synchronization information in an editing process, and a simulation function.

Referring to FIG. 1, the graphics file inputting unit 110 loads graphics files selected by a user from a directory in a computer or a web site on the Internet, for example, various graphics files such as BMP, JPG, and GIF files. The continuous image list creator 112 creates a list of the various loaded graphics files in the order in which the graphics files are input. However, when there is a predetermined order set by the user, the list is created in the order set by the user.

Information items on the respective images are always traced internally in structure in order to create the list. The user can give an additional image effect to the respective images in the list. For example, the user can set fade in, wipe in, and zoom in effects and the duration times of the effects.

The audio file inputting unit 120 loads an audio file selected by the user from a designated file position in a computer. The user can be informed of the kind, the reproduction time, and the size of the loaded audio file.

The text file inputting unit 130 loads a text file selected by the user from a designated file position in a computer. The text aligner 132 automatically aligns text in the loaded text file in predetermined units which can be reproduced by a reproduction device, for example, in units of lines. When the user sets the number of pixels which can be displayed in a line, the text aligner 132 automatically aligns the text according to the set number.

The graphic reproducer 114, the audio reproducer 122, and the text reproducer 134 operate in response to respective control signals generated by the control signal generator 140. The audio reproducer 122 reproduces the loaded audio file. The start and end of reproduction of audio are determined in response to a first control signal generated by the control signal generator 140. The graphic reproducer 114 sequentially displays the images registered in the list one by one. A duration for which an image is continuously displayed is set in response to a second control signal generated by the control signal generator 140. The text reproducer 134 sequentially displays the aligned text in units of lines. A duration for which the current text is continuously displayed is set in response to a third control signal generated by the control signal generator 140.

When in automatic mode, the control signal generator 140 can automatically generate first through third control signals so that the graphic, the audio, and the text are reproduced in synchronization with each other, by checking information on an audio file, that is, the reproduction time, the number of graphic images to be displayed during the reproduction time, and the number of lines of the aligned text, and calculating the duration for which an image and the current text are continuously displayed. The control signal generator can also generate first through third control signals at time intervals desired by a user when the control signal generator is set to a manual mode.

The storage unit 150 stores the graphic, audio, and text reproduced in synchronization with each other by the graphic reproducer 114, the audio reproducer 122, and the text reproducer 134. The multimedia file generator 160 generates the stored data as a multimedia file, preferably using the SMIL format, and outputs the generated multimedia file to the multimedia player 170 or the simulator 180 in response to a selection signal from the control signal generator 140. This is determined according to the selection of the user. The simulator 180 reproduces the multimedia file directly created by the multimedia file generator 160 on the computer screen.

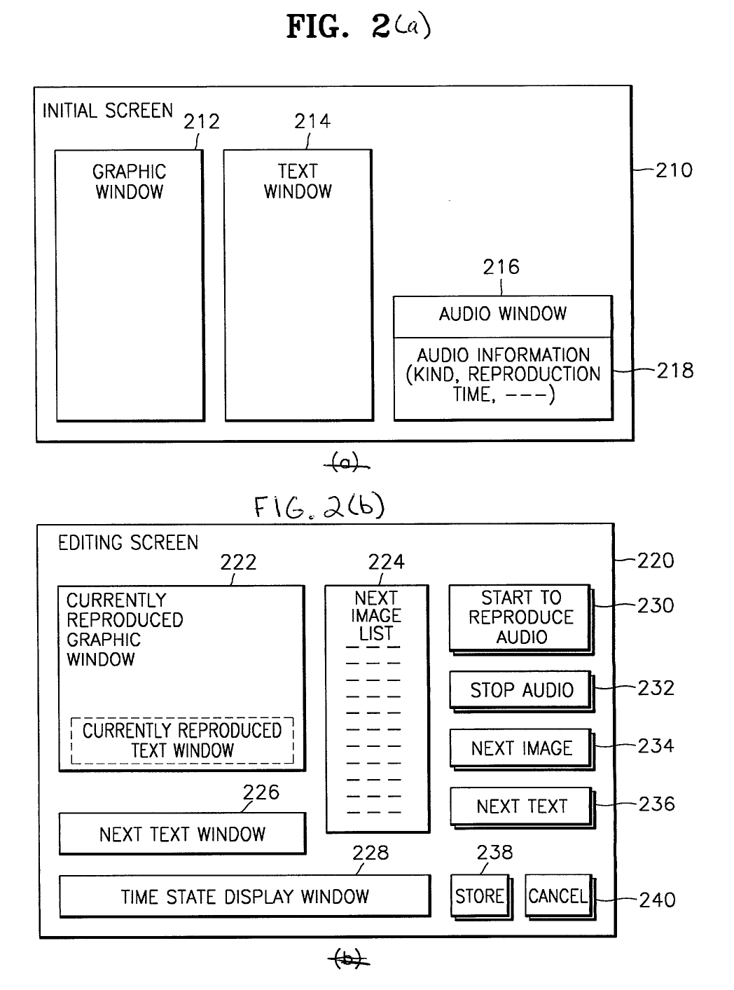

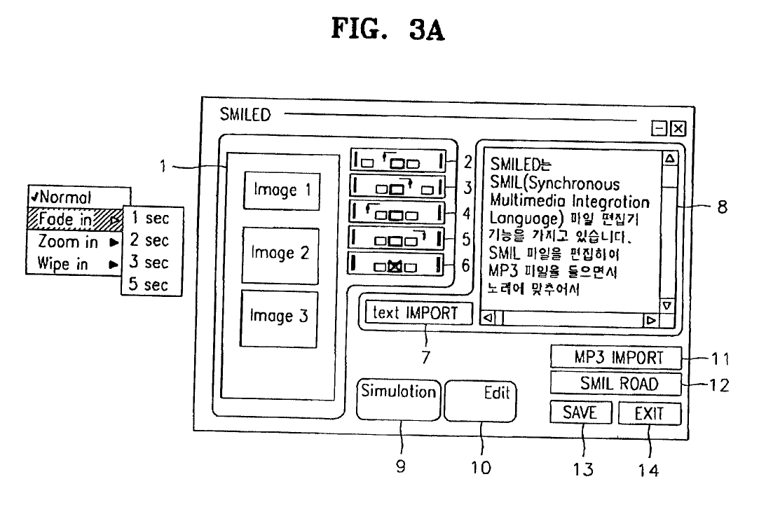

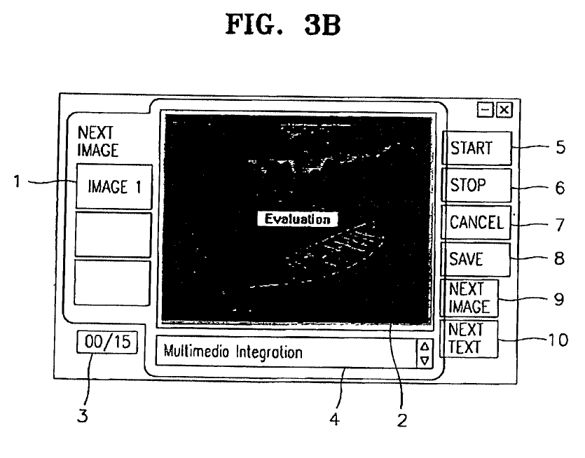

FIGS. 2(a) and 2(b) show preferred embodiments of the structures of computer screens according to the authoring method of the present invention. FIG. 2(a) shows an initial screen and FIG. 2(b) shows an editing screen. FIGS. 3(a) and 3(b) show the structures of actual computer screens corresponding to FIGS. 2(a) and 2(b).

In FIG. 2(a), an initial screen 210 basically includes a graphic window 212, a text window 214, and an audio window 216. The graphic window 212 displays various graphics files loaded on the path designated by the user in the order they were input or in an order set by the user.

In FIG. 3(a), a graphics file list is displayed on a screen 1 corresponding to the graphic window 212. The order in which the graphics files are displayed on the screen is the same as the order in which the graphics files appear in the image list. The order of the graphics files can be changed by drag and drop using a mouse. Also, when the right button of the mouse is clicked on an image, a pop-up menu is additionally shown on the left.

The user can set various image output types and effects such as fade in/out, zoom in/out, and wide in/out, and designate an effective time (for example, one second, two seconds, three seconds, or five seconds), using the pop-up menu. When the right button of the mouse is clicked on the left of the image, an image in effect menu is shown. When the right button of the mouse is clicked on the right of the image, an image out effect menu is shown.

Additionally, the graphic window 212 can include buttons 2 through 6 having the function of adding/deleting the image list, which are shown in FIG. 3(a). When the buttons are clicked by the mouse, a window which can load the graphics file is shown and the user inserts the selected graphics file into a previous image list or deletes the selected graphics file from the previous image list.

For example, when the user selects new images by a first button 2 after selecting an image on the image list of the screen 1, the new images are added right before the image currently selected in the image list. New images selected by a second button 3 are added right after the image currently selected in the image list. New images selected by a third button 4 and a fourth button 5 are added to the head and the end of the image list, respectively. When a fifth button 6 is clicked, the image currently selected in the image list is deleted.

In FIG. 2(a), the text file loaded on the path designated by the user is automatically aligned and displayed on the text window 214 in the initial screen 210. Also, the user can directly work on the text window 214. The user can bring an audio file from the designated path through an audio window 216, on which audio information 218 on the file is displayed.

Referring to FIG. 3(a) in relation to the text window 214 and the audio window 216, text and audio file opening buttons 7 and 11 are included in a screen 8 corresponding to the text window 214. When the user clicks the button 7 and loads the text file, the content of the text file is displayed on the screen 8. At this time, the text is aligned in units of lines according to the number of characters which can be displayed in a line. Also, the user loads the audio file by clicking the button 11.

Additionally, a simulation button 9 for previewing an edited multimedia file, preferably, a SMIL file, an editing button 10 for letting the user input time information with the image list and the text, a button 12 for loading the existing SMIL file, a storage button 13 for storing the currently edited SMIL file, and a button 14 for exiting are included in the initial screen shown in FIG. 3(a).

In FIG. 2(b), an editing screen 220 basically includes a currently reproduced graphic window 222, a next image list window 224, a next text window 226, a time state display window 228, an audio reproduction starting button 230, an audio stopping button 232, a conversion into a next image button 234, a conversion into a next text button 236, a storage button 238, and a canceling button 240.

The initial image is displayed on the currently reproduced graphic window 222 the moment the user clicks the audio reproduction starting button 230. The images registered in the next image list window 224 are sequentially displayed at previously set time intervals in synchronization with audio reproduction.

The text of the initial line is displayed on the currently reproduced text window included in the currently reproduced graphic window 222 or constituted of an additional screen the moment the user clicks the audio reproduction starting button 230. Text in units of lines, which are provided in the next text window 226, are sequentially displayed at previously set time intervals in synchronization with the audio reproduction.

At this time, the images registered in the next image list 224 and the text in units of lines provided in the next text window 226 can be set to be sequentially displayed on the currently reproduced graphic window 222 and the currently reproduced text window, respectively, when the user directly clicks the conversion into a next image button 234 and the conversion into next text button 236.

When the user clicks the conversion into next image button 234 and the conversion into next text button 236, information on the selected next image and text is internally converted at the point of time at which the graphic and text start to be reproduced and the duration for which the graphic and text are reproduced in the SMIL format, and is recorded. The reproduced audio, graphic, and text are stored by clicking the storage button 230 on the basis of the point of time at which the audio, graphic, text are completed by repeating the above operations, and the SMIL file is generated.

In FIG. 2(b), the time state displaying window 228 displays the remaining audio reproduction time. For example, when an audio file of three minutes and fifty seconds is loaded, it is shown that the audio reproduction time is reduced in units of seconds from 3:50 to 0:00. When the SMIL file is generated, the editing screen 220 is returned to the initial screen 210 and simulation is performed like in the multimedia player (referring to FIG. 3(a) which shows FIG. 2(a) in detail, there exists a simulation button 9).

As mentioned above, in the authoring apparatus and method for creating a multimedia file, according to the present invention, it is possible to provide source files to various multimedia products, and particularly, to let users who use the Internet easily create music videos and digital albums.

What is claimed is:

1. An authoring apparatus for creating a multimedia file as a source file with respect to a multimedia product, comprising:
an editor for loading a graphics file, an audio file, and a text file which are selected from respective file positions in a computer, generating an audio file in response to a first control signal for controlling the start and end of audio, and reproducing the graphics file and the text file in response to second and third control signals which are generated in synchronization with the reproduction of the audio file, respectively;
a control signal generator for checking reproduction time information on the loaded audio file and generating the first through third control signals;
a storage unit for storing a graphic image and audio and text data, which are reproduced by the editor; and
a multimedia file generator for generating the stored data as a multimedia file using a predetermined format.

2. The apparatus of claim 1, wherein the graphics file, the audio file, and the text file are selected from their respective file positions in a computer designated by a user.

3. The apparatus of claim 1, wherein the editor comprises:
an audio reproducer for reproducing an audio file in response to the first control signal;
a continuous image list creator for creating an image list in a predetermined order set by a user with respect to sequentially loaded graphics files;
a graphic reproducer for sequentially displaying the images registered in the image list one by one in response to the second control signal, said image list displayed on a graphic window on a screen for interfacing with a user;
a text aligner for automatically aligning text in a loaded text file in predetermined units; and
a text reproducer for displaying the aligned text on the text window on the screen in the predetermined units in response to the third control signal.

4. The apparatus of claim 3, wherein the predetermined units are units of lines determined by a number of pixels set by a user.

5. The apparatus of claim 3, wherein the control signal generator checks a reproduction time duration of an audio file, the number of graphic images to be displayed throughout the reproduction time duration, and the number of lines of the aligned texts, calculates a time duration for which an image and current text are continuously displayed, and automatically generates first through third control signals when the control signal generator is set to be in an automatic mode.

6. The apparatus of claim 3, wherein the control signal generator generates the first through third control signals at time intervals desired by a user when the control signal generator is set to be in a manual mode.

7. The apparatus of claim 1, further comprising a simulator for reproducing a multimedia file directly created by a user through a file generator on a screen for interfacing with the user.

8. The apparatus of claim 1, wherein the predetermined format is synchronized multimedia integration language (SMIL).

9. An authoring method for creating a multimedia file as a source file with respect to a multimedia product, comprising the steps Of:
(a) loading a graphics file, an audio file, and a text file selected from a respective file position in a computer;
(b) reproducing the audio file and reproducing the graphic and text files in synchronization with the audio reproduction when the user selects an audio reproduction starting button provided on a screen for interfacing with a user;
(c) storing a reproduced graphic image and audio and text data; and
(d) generating the stored data as a multimedia file using a predetermined format.

10. The method of claim 9, wherein the graphics file, the audio file, and the text file are selected from their respective file positions in a computer designated by a user.

11. The method of claim 9, wherein the step (b) comprises the steps of:
(b1) creating an image list of sequentially loaded graphics files in an order predetermined by the user and aligning text in a loaded text file in predetermined units of lines according to a number of pixels determined by the user;
(b2) reproducing an audio file and displaying an initial graphic image and the text of an initial line in synchronization with the audio reproduction; and
(b3) sequentially displaying the next image registered in the image list and the next text in units of lines at previously set time intervals in synchronization with the audio reproduction.

12. The method of claim 9, wherein the step (b) comprises:
(b1) creating an image list of sequentially loaded graphics files in an order predetermined by the user and aligning text in a loaded text file in predetermined units of lines according to a number of pixels determined by the user;
(b2) reproducing an audio file and displaying an initial graphic image and the text of an initial line in synchronization with the audio reproduction; and
(b3) sequentially displaying the next image registered in the image list and the next text in units of lines when the user selects a conversion into a next image button and a conversion into next text button.

13. The method of claim 12, wherein in step (b3), the conversion into next image button and the conversion into next text button are provided on the screen.

14. The method of claim 9, wherein in the step (d), the predetermined format is SMIL.
